(19) United States
(12) Patent Application Publication
(10) Pub. No.: US 2023/0166738 A1
(43) Pub. Date: Jun. 1, 2023

(54) OPERATOR REACTION TIME CAULCATION FOR STREET VEHICLES

(71) Applicant: Continental Automotive Systems, Inc., Auburn Hills, MI (US)

(72) Inventors: Christopher Allen Harrison, Oberursel (DE); Timothy Buchert, Oxford, MI (US)

(73) Assignee: Continental Automotive Systems, Inc., Auburn Hills, MI (US)

(21) Appl. No.: 17/456,935

(22) Filed: Nov. 30, 2021

(51) Int. Cl. B60W 40/09; G08G 1/01

(52) U.S. Cl. CPC B60W 40/09; G08G 1/0145; G08G 1/0133; B60W 2420/42; B60W 2540/229

(57) ABSTRACT

An operator reaction time calculation system for calculating a reaction time of an operator of a motor vehicle and a method of calculating the reaction time of an operator of the motor vehicle. The operator reaction time may be determined according to detection of a launch signal within an image and measuring a reaction of the operator launching the motor vehicle in response to the launch signal.

### BACKGROUND

### 1. Field

The present application relates to an operator reaction time calculation system, and more particularly to a calculation system for reaction time of an operator of a motor vehicle and a method of calculating the reaction time of an operator of the motor vehicle.

### 2. Description of Related Art

Automobile manufacturers provide many different types of automobiles. For each type of motor vehicle, an automobile manufacturer may provide different optional packages. For example, a particular type of motor vehicle may be manufactured in varying levels of interior trim, to increase convenience, improve usability, and augment the user experience while driving or riding as a passenger within a motor vehicle. Additionally, a particular type of motor vehicle may be manufactured according to varying levels of performance options, to improve speed, acceleration, cornering, braking, and other operational characteristics of the motor vehicle.

High performance motor vehicles include systems and components for increasing the operational capabilities of a motor vehicle. In addition to varying levels of component packages offered by automobile manufacturers, after market components may be utilized on a motor vehicle to further increase the operational capabilities thereof.

One type of frequent configuration of a high performance vehicle, whether configured by an automobile manufacturer or customized through use of after-market components, is the track rated class of motor vehicle. These classes of motor vehicles typically include highly tuned mechanical components for maximizing speed, acceleration, cornering, etc. of a motor vehicle in the context of vehicle racing. Conversely, these types of motor vehicles might also eschew interior convenience packages, for example to reduce motor vehicle weight, improve fuel economy, or improve motor vehicle safety under high speed or high stress conditions.

In the context of racing high performance vehicles, reaction time of the operator is an important competition aspect. Given equivalent motor vehicle characteristics and performance parameters, the operator of the motor vehicle that more quickly reacts to an initialization or start signal will achieve higher racing success. Accordingly, an operator reaction time calculation system of a motor vehicle for calculating a reaction time of an operator would be beneficial to inform a motor vehicle operator of the reaction time, to improve racing training and racing performance.

### SUMMARY

Aspects of embodiments of the present application relate to an operator reaction time calculation system for calculating a reaction time of an operator.

According to an aspect of an embodiment, there is provided an operator reaction time calculation system for calculating a reaction time of an operator including a camera configured to capture an image, a controller configured to detect in the image a launch signal that signals the operator of a motor vehicle to launch the motor vehicle from a stopped position, and a sensor configured to output a signal corresponding to a reaction of the operator launching the motor vehicle in response to the launch signal, wherein the controller is configured to determine an elapsed time of the reaction of the operator launching the motor vehicle in response to the launch signal and output the elapsed time as the reaction time of the operator of the motor vehicle to the launch signal.

According to an aspect of an embodiment, there is provided a method of calculating a reaction time of an operator of a motor vehicle, the method including capturing an image, detecting in the image a launch signal that signals the operator of the motor vehicle to launch the motor vehicle from a stopped position, detecting a reaction of the operator launching the motor vehicle in response to the launch signal, determining an elapsed time of the reaction of the operator launching the motor vehicle in response to the launch signal, and outputting the elapsed time as the reaction time of the operator of the motor vehicle to the launch signal.

According to an aspect of an embodiment, there is provided a non-transitory computer-readable recording medium having embodied thereon a program, which when executed by a processor causes the processor to control a method of calculating a reaction time of an operator of a motor vehicle, the method including capturing an image, detecting in the image a launch signal that signals the operator of the motor vehicle to launch the motor vehicle from a stopped position, detecting a reaction of the operator launching the motor vehicle in response to the launch signal, determining an elapsed time of the reaction of the operator launching the motor vehicle in response to the launch signal, and outputting the elapsed time as the reaction time of the operator of the motor vehicle to the launch signal.

### BRIEF DESCRIPTION OF THE DRAWINGS

The above and other aspects will be more clearly understood from the following brief description taken in conjunction with the accompanying drawings, in which:

FIG. 1 is a diagram illustrating an operator reaction time calculation system, according to an embodiment; and

FIGS. 2A, 2B, and 2C are diagrams illustrating the operation of an operator reaction time calculation system, according to an embodiment.

### DETAILED DESCRIPTION

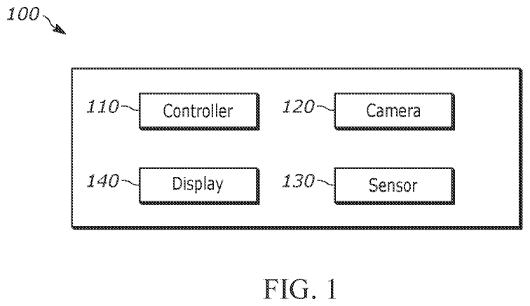

FIG. 1 is a diagram illustrating an operator reaction time calculation system, according to an embodiment.

An operator reaction time calculation system 100 according to an embodiment includes a controller 110, a camera 120, a sensor 130, and a display 140.

The controller 110 may be a central processing unit (CPU), electronic control unit (ECU), microprocessor, application-specific integrated circuit (ASIC), or other programmable circuitry. The controller 110 may include memory, such as random access memory (RAM), cache memory, or other memory programmed to store computer-readable instructions executable by the controller 110 for controlling operations of the operator reaction time calculation system 100.

The computer-readable instructions executed under the control of the controller 110 may cause the controller 110 to control the operator reaction time calculation system 100 to perform a method of calculating reaction time of the operator of a motor vehicle. The computer-readable instructions may be recorded on any computer-readable media, including disk, memory, or non-transitory medium.

The controller 110 may be communicatively coupled to the camera 120, the sensor 130, and the display 140 through, for example, a wired bus or wireless communication interface that performs communication by one or more wireless protocols, such as WiFi, Bluetooth, or other applicable wireless communication protocol or standard.

The camera 120 may include any form of imaging device, including a charge-coupled device (CCD) and an active pixel sensor, such as a complementary metal-oxide semiconductor (CMOS) or N-type MOS sensor. The camera may capture an image of a traffic signal, racing signal, or other signal visually identifiable to the camera 120 and the operator of the motor vehicle.

The sensor 130 may be, for example, a displacement sensor, coupled to a pedal of the motor vehicle, for measuring displacement of the pedal by the operator of the motor vehicle, one or more wheel speed sensors coupled to one or more wheels of the motor vehicle for measuring a speed of rotation of the one or more wheels, or an acceleration sensor coupled to the motor vehicle for measuring an acceleration of the motor vehicle.

The controller 110 may receive one or more images from the camera 120.

In an embodiment, the controller 110 may receive an actuation signal from an operator of the motor vehicle to commence the process of calculating reaction time of the operator of the motor vehicle. In response to receiving the actuation signal, the controller 120 may signal the camera 120 to transmit one or more images from the camera 120 to the controller 110. The actuation signal may be input by the operator of the motor vehicle through actuation of a switch, button, or the like, or a human-machine interface (HMI) including a touch screen, voice command interface, or the like, for initiating the process of calculating reaction time of the operator of the motor vehicle.

In an alternative embodiment, the controller 110 may continuously receive signals of one or more images from the camera 120, without receiving the actuation signal from an operator of the motor vehicle to commence the process of calculating reaction time of the operator of the motor vehicle. For example, the controller 110 may continuously receive images from the camera 120 in the context of an image-based safety detection system for detecting pedestrians, other motor vehicles, and the like.

In response to receiving the one or more images from the camera, the controller 110 may detect, within the one or more images, a traffic signal, a racing signal, or any other signal visually identifiable to the camera 120 and the operator of the motor vehicle for signaling to launch the motor vehicle from a stopped position. A signal for signaling the operator of the motor vehicle to launch the motor vehicle from a stopped position may be termed a launch signal.

In response to identifying and detecting the traffic signal, the racing signal, or the launch signal, the controller 110 may detect a state of the traffic signal, the racing signal, or the launch signal. In the instance of a traffic signal, the controller may execute an image recognition algorithm to recognize a state of the traffic signal. For example, a state of the traffic signal may be a state in which the traffic signal currently emits a green light, a yellow light, or a red light. Alternatively, a state of the traffic signal may be a state in which the traffic signal currently emits light from a top (or topmost) position of a top (or topmost) light of the traffic signal, a middle position of a middle light of the traffic signal, or a bottom (or bottommost) light of a bottom (or bottommost) position of the traffic signal.

The controller 110 recognizes a stopped state of the traffic signal, the racing signal, or the launch signal. For example, in the instance of a traffic signal, the controller 110 may execute an image classification algorithm to classify that the traffic light is in a stopped state in which the traffic light emits a red light.

In response to recognizing a stopped state of the traffic signal, the racing signal, or the launch signal, the controller 110 determines whether the state changes from the stopped state to an active (or launched) state, for signaling the operator to launch the motor vehicle from a stopped position to a moving position. For example, in the instance of a traffic signal, the controller 110 may recognize the traffic light changes from the stopped state to a launch state, in which the traffic light emits a green light.

In response to detecting the launch state, the controller 110 initiates a timer. The timer may be any form of digital, electronic, analog or other timer for tracking a time elapsed since initiation of the timer by the controller 110.

In response to initiation of the timer, the controller 110 may actively poll the sensor 130 for a signal corresponding to a reaction of the operator of the motor vehicle to the launch signal. Alternatively, the sensor 130 may transmit a signal to the controller 110 corresponding to a reaction of the operator of the motor vehicle to the launch signal. For example, in the instance of a displacement sensor, the sensor 130 may output a signal corresponding to an amount of displacement of a pedal of the motor vehicle, which is indicative of reaction of the operator of the motor vehicle to the launch signal. In the instance of an acceleration sensor, the sensor 130 may output a signal corresponding to an acceleration of the motor vehicle from the stopped position, which is indicative of reaction of the operator of the motor vehicle to the launch signal. In the instance of the wheel speed sensor, the sensor 130 may output a signal corresponding to a rotation speed of one or more wheels of the motor vehicle from the stopped position, which is indicative of reaction of the operator of the motor vehicle to the launch signal. Of course, the type of sensor 130 may not be limited to the above-described examples, and may be any sensor for detecting reaction of the operator of the motor vehicle to the launch signal and outputting a signal corresponding to the reaction to the controller 110.

In response to receiving from the sensor 130 the signal corresponding to a reaction of the operator of the motor vehicle to the launch signal, the controller 110 determines a time elapsed since the initiation of the timer until receipt of the signal from the sensor 130. The controller 110 may record the time elapsed since the initiation of the timer until receipt of the signal from the sensor 130 in a memory, such as a register, table, database, or other memory storage structure.

The controller 110 may output or control the display 140 to output the recorded time elapsed since the initiation of the timer until receipt of the signal from the sensor 130 to the display 140, as the reaction time of the operator of the motor vehicle to the launch signal.

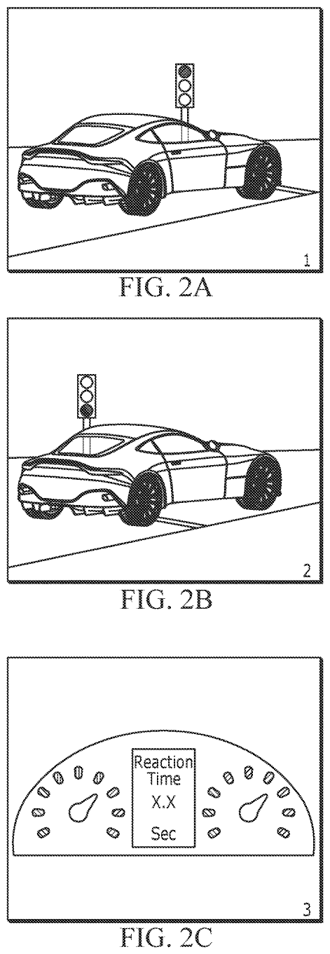

FIGS. 2A, 2B, and 2C are diagrams illustrating the operation of an operator reaction time calculation system, according to an embodiment.

As illustrated in view FIG. 2A, a driver or operator of a motor vehicle may be waiting at a traffic signal. The traffic signal may signal to the operator of the motor vehicle that the motor vehicle should be in a stopped state, for example by emitting a red light from a topmost light of the traffic signal.

The driver of the motor vehicle may provide to the operator reaction time calculation system an actuation signal to commence the process of calculating reaction time of the operator of the motor vehicle. For example, the actuation signal may be input by the operator of the motor vehicle through actuation of a switch, button, or the like, or a human-machine interface (HMI) including a touch screen, voice command interface, or the like, for initiating the process of calculating reaction time of the operator of the motor vehicle.

In response to receiving the actuation signal, the operator reaction time calculation system may obtain one or more images from a camera of the motor vehicle.

The operator reaction time calculation system may detect the traffic signal within the one or more images.

In response to detecting the traffic signal, the operator reaction time calculation system may detect a state of the traffic signal. In view FIG. 2A, the operator reaction time calculation system may recognize a state of the traffic signal corresponding to the red light. Accordingly, the operator reaction time calculation system recognizes a stopped state of the traffic signal.

In view FIG. 2B, the operator reaction time calculation system determines whether the state changes from the stopped state to an active (or launched) state, for signaling the operator to launch the motor vehicle from a stopped position to a moving position. For example, view FIG. 2B, the operator reaction time calculation system may recognize the traffic signal changes from the stopped state to a launch state, in which the traffic signal emits a green light.

In response to detecting the launch state, a timer is initiated.

As shown in view FIG. 2C, the operator reaction time calculation system may detect a signal corresponding to a reaction of the operator of the motor vehicle to the launch signal. For example, in the instance of a displacement sensor, the sensor may output a signal corresponding to an amount of displacement of a pedal of the motor vehicle, which is indicative of reaction of the operator of the motor vehicle to the launch signal. In the instance of an acceleration sensor, the sensor may output a signal corresponding to an acceleration of the motor vehicle from the stopped position, which is indicative of reaction of the operator of the motor vehicle to the launch signal. In the instance of the wheel speed sensor, the sensor may output a signal corresponding to a rotation speed of one or more wheels of the motor vehicle from the stopped position, which is indicative of reaction of the operator of the motor vehicle to the launch signal.

In response to receiving the signal corresponding to a reaction of the operator of the motor vehicle to the launch signal, the operator reaction time calculation system determines a time elapsed since the initiation of the timer until receipt of the signal from the sensor.

As shown in view FIG. 2C, the operator reaction time calculation system may display the reaction time of the operator of the motor vehicle to the launch signal.

As described above, an operator reaction time calculation system provides a locally calculated reaction time of the operator of the motor vehicle to the launch signal. Accordingly, the operator of the motor vehicle may be accurately and quickly informed of a reaction time.

1. An operator reaction time calculation system comprising:
a camera configured to capture an image;
a controller configured to detect in the image a launch signal that signals the operator of a motor vehicle to launch the motor vehicle from a stopped position; and
a sensor configured to output a signal corresponding to a reaction of the operator launching the motor vehicle in response to the launch signal,
wherein the controller is configured to determine an elapsed time of the reaction of the operator launching the motor vehicle in response to the launch signal and output the elapsed time as the reaction time of the operator of the motor vehicle to the launch signal.

2. The operator reaction time calculation system of claim 1, wherein the controller is configured to initiate a timer in response to detecting the launch signal in the image.

3. The operator reaction time calculation system of claim 2, wherein the controller is configured to determine the elapsed time as an elapsed time of the reaction of the operator launching the motor vehicle in response to the launch signal as a time elapsed since initiation of the timer until receipt of the signal from the sensor.

4. The operator reaction time calculation system of claim 3, further comprising:
a display,
wherein the controller controls the display to display the elapsed time as the reaction time of the operator of the motor vehicle to the launch signal.

5. The operator reaction time calculation system of claim 4, wherein the launch signal comprises a signal of a traffic signal.

6. The operator reaction time calculation system of claim 4, wherein the launch signal comprises a signal of a racing signal.

7. The operator reaction time calculation system of claim 4, wherein the sensor comprises a displacement sensor, coupled to a pedal of the motor vehicle, for measuring displacement of the pedal by the operator of the motor vehicle.

8. The operator reaction time calculation system of claim 4, wherein the sensor comprises one or more wheel speed sensors coupled to one or more wheels of the motor vehicle for measuring a speed of rotation of the one or more wheels.

9. The operator reaction time calculation system of claim 4, wherein the sensor comprises an acceleration sensor coupled to the motor vehicle for measuring an acceleration of the motor vehicle.

10. A method of calculating a reaction time of an operator of a motor vehicle, the method comprising:
capturing an image;
detecting in the image a launch signal that signals the operator of the motor vehicle to launch the motor vehicle from a stopped position;
detecting a reaction of the operator launching the motor vehicle in response to the launch signal;
determining an elapsed time of the reaction of the operator launching the motor vehicle in response to the launch signal; and
outputting the elapsed time as the reaction time of the operator of the motor vehicle to the launch signal.

11. The method of claim 10, further comprising:
Initiating a timer in response to detecting the launch signal in the image.

12. The method of claim 11, wherein determining the elapsed time comprises:
determining the elapsed time as an elapsed time of the reaction of the operator launching the motor vehicle in response to the launch signal as a time elapsed since initiation of the timer until detecting the reaction of the operator launching the motor vehicle.

13. The method of claim 12, wherein the outputting comprises displaying the elapsed time as the reaction time of the operator of the motor vehicle to the launch signal.

14. The method of claim 13, wherein the launch signal comprises a signal of a traffic signal.

15. The method of claim 13, wherein the launch signal comprises a signal of a racing signal.

16. The method of claim 13, wherein the detecting comprises detecting by a displacement sensor, coupled to a pedal of the motor vehicle, displacement of the pedal by the operator of the motor vehicle.

17. The method of claim 13, wherein the detecting comprises detecting by one or more wheel speed sensors coupled to one or more wheels of the motor vehicle a speed of rotation of the one or more wheels.

18. The method of claim 13, wherein the detecting comprises detecting by an acceleration sensor coupled to the motor vehicle an acceleration of the motor vehicle.

19. A non-transitory computer-readable recording medium having embodied thereon a program, which when executed by a processor causes the processor to control a method of calculating a reaction time of an operator of a motor vehicle, the method comprising:
capturing an image;
detecting in the image a launch signal that signals the operator of the motor vehicle to launch the motor vehicle from a stopped position;
detecting a reaction of the operator launching the motor vehicle in response to the launch signal;
determining an elapsed time of the reaction of the operator launching the motor vehicle in response to the launch signal; and
outputting the elapsed time as the reaction time of the operator of the motor vehicle to the launch signal.
